(19) United States
(12) Patent Application Publication
(10) Pub. No.: US 2016/0139860 A1
(43) Pub. Date: May 19, 2016

(54) COMMUNICATION SYSTEM, IMAGE FORMING APPARATUS AND COMMUNICATION METHOD

(71) Applicant: FUJI XEROX CO., LTD., Tokyo (JP)

(72) Inventor: Yasuaki MITOBE, Yokohama-shi (JP)

(73) Assignee: FUJI XEROX CO., LTD., Tokyo (JP)

(21) Appl. No.: 14/705,090

(22) Filed: May 6, 2015

(30) Foreign Application Priority Data
Nov. 17, 2014 (JP) 2014-232575

(51) Int. Cl. G06F 3/12

(52) U.S. Cl. CPC G06F 3/1234; G06F 3/121; G06F 3/1279

(57) ABSTRACT

A communication system includes: a master controller that generates a packet; and plural slave controllers that accept the packet generated by the master controller, wherein the plural slave controllers are serially connected via a serial communication line, a first slave controller of the plural slave controllers is connected to the master controller via the serial communication line, and each of the plural slave controllers, upon obtaining the packet generated by the master controller, converts a part of the packet from a serial signal into a parallel signal, and if the packet is not addressed to the slave controller itself, discards the packet or transfers the packet to a later-stage slave controller connected via the serial communication line.

### CROSS REFERENCE TO RELATED APPLICATION

This application is based on and claims priority under 35 USC §119 from Japanese Patent Application No. 2014-232575 filed Nov. 17, 2014.

### BACKGROUND

1. Technical Field

The present invention relates to a communication system, an image forming apparatus and a communication method.

2. Related Art

There exists a communication system having plural communication devices connected thereto and making error determination for received data.

### SUMMARY

According to an aspect of the present invention, there is provided a communication system including: a master controller that generates a packet; and plural slave controllers that accept the packet generated by the master controller, wherein the plural slave controllers are serially connected via a serial communication line, a first slave controller of the plural slave controllers is connected to the master controller via the serial communication line, and each of the plural slave controllers, upon obtaining the packet generated by the master controller, converts a part of the packet from a serial signal into a parallel signal, and if the packet is not addressed to the slave controller itself, discards the packet or transfers the packet to a later-stage slave controller connected via the serial communication line.

### BRIEF DESCRIPTION OF THE DRAWINGS

An exemplary embodiment of the present invention will be described in detail based on the following figures, wherein:

FIG. 1 is a diagram showing a configuration example of an image forming apparatus according to the exemplary embodiment;

FIG. 2 is a diagram showing a configuration example of a master controller;

FIG. 3 is a diagram showing a configuration example of a slave controller;

FIG. 4A is a diagram showing an example of a data structure of a packet that is generated by the master controller and transmitted to the slave controller;

FIG. 4B is a diagram showing an example of a data structure of an ACK packet that is transmitted to the master controller as a destination address from the slave controller;

FIG. 4C is a diagram showing an example of a data structure of a NACK packet that is transmitted to the master controller as a destination address from the slave controller;

FIG. 5 is a flowchart showing an example of procedures in which the slave controller processes the packet generated by the master controller; and

FIG. 6 is a diagram illustrating an example of a process in a case where noise is applied to the packet.

### DETAILED DESCRIPTION

Hereinafter, an exemplary embodiment according to the present invention will be described in detail with reference to attached drawings.

Here, description will be given of an apparatus which includes a master controller and slave controllers, and to which a communication system of a master-slave method that transmits and receives control data between these controllers by serial communication is applied while taking an image forming apparatus as an example.

### <Entire Configuration of Image Forming Apparatus>

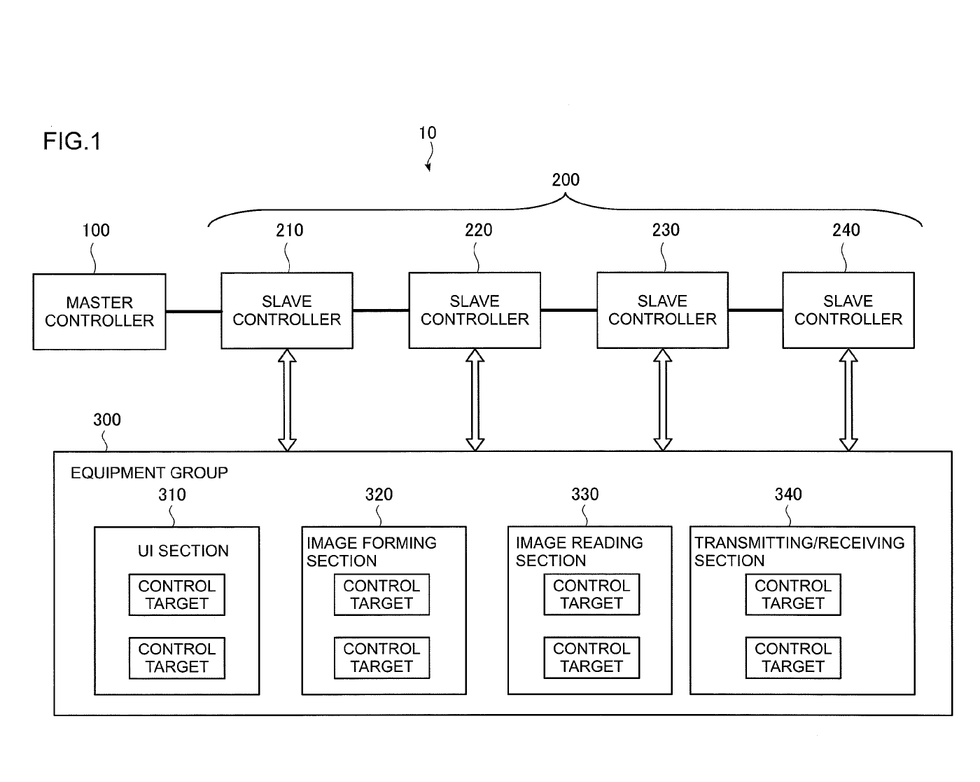

FIG. 1 is a diagram showing a configuration example of an image forming apparatus 10 according to the exemplary embodiment.

The image forming apparatus 10 includes, for example, a scanning function, a printing function, a copying function, a facsimile function and the like.

The image forming apparatus 10 includes: an image reading section 330 that reads an image recorded on a recording medium such as a paper sheet; an image forming section 320 that forms an image on a recording medium; a user interface section 310 (hereinafter, represented as a UI section 310) that accepts instructions related to turning on/off of the power and operations using the scanning function, the printing function, the copying function and the facsimile function from a user and displays a message to a user; and a transmitting/receiving section 340 that transmits and receives data with, for example, a terminal device (not shown), a facsimile device (not shown), a server device (not shown) and the like provided at the outside via a communication line (not shown).

Moreover, the image forming apparatus 10 includes a master controller 100 and plural slave controllers (in the exemplary embodiment, there are provided four slave controllers, and in the case where each of the slave controllers is not distinguished, represented as a slave controller 200) that control operations of the image reading section 330, the image forming section 320, the UI section 310 and the transmitting/receiving section 340. The master controller 100 and the plural slave controllers 200 are configured as a communication system by cascade-connecting so as to enable serial communication mutually with an adjacent controller. It should be noted that the image reading section 330, the image forming section 320, the UI section 310 and the transmitting/receiving section 340 are collectively referred to as an equipment group 300, and in the case where each of them is not distinguished, represented as a functional block. Moreover, each functional block includes one or more control targets to be controlled by the master controller 100 and the slave controllers 200.

Here, the plural slave controllers 200 are serially connected via the serial communication line. In the configuration example shown in FIG. 1, as the slave controllers 200, there are provided the slave controller 210, the slave controller 220, the slave controller 230 and the slave controller 240. Then, the slave controller 210, which is the first of the plural slave controllers 200, is connected to the master controller 100 via the serial communication line. In a similar manner, data transmission and reception by serial communication is carried out between each of the slave controller 210 and the slave controller 220, the slave controller 220 and the slave controller 230, and the slave controller 230 and the slave controller 240. It should be noted that, in the configuration example shown in FIG. 1, it is assumed that the configuration includes the four slave controllers 200 that are connected; however, in the exemplary embodiment, the configuration may include slave controllers 200 less than four or not less than five that are connected.

Moreover, each slave controller 200 is provided with an ID so that the number becomes larger in the order from the first slave controller 210 toward the last slave controller 240. In the example shown in FIG. 1, it is assumed that the ID of the slave controller 210 is “01”, the ID of the slave controller 220 is “02”, the ID of the slave controller 230 is “03” and the ID of the slave controller 240 is “04”. Moreover, the master controller 100 and each slave controller 200 recognize the ID assigned to each slave controller 200. That is, the master controller 100 recognizes that the four slave controllers 200 having the IDs 01 to 04 are connected thereto. Moreover, each slave controller 200 recognizes the ID assigned to itself and also recognizes the respective IDs assigned to other slave controllers 200. In the exemplary embodiment, the ID is used as an example of identifying information.

Next, functions of the master controller 100 and the slave controllers 200 will be described.

The master controller 100 controls the image forming apparatus 10 as a whole. Here, the master controller 100 monitors the state of operations of each slave controller 200 and each functional block, and generates a packet (a control command for controlling the control target, control data, and the like) for controlling the image forming apparatus 10, to thereby transmit thereof to each slave controller 200 via serial communication. In the packet transmitted from the master controller 100, the ID of the slave controller 200 as the destination address is included. For example, in a case where a packet is transmitted from the master controller 100 to a later-stage slave controller 200 as the destination address, the packet passes through the slave controllers 200 in the earlier stages.

The slave controller 200 accepts a packet, which is addressed to itself and received from an earlier-stage slave controller 200 provided adjacent thereto (in the case of the slave controller 210, since there is no earlier-stage slave controller 200, the master controller 100), and transmits data, such as control data, to a control target in a functional block. Here, in the case where the received packet is addressed to a later-stage slave controller 200, the slave controller 200 transfers the packet to a later-stage slave controller 200 provided adjacent thereto (hereinafter, referred to as a next-stage slave controller 200).

Moreover, the slave controller 200 transmits data transmitted from a control target in a functional block (such as status data indicating a status of a control target or sensor data in the case where the control target is a sensor) or data received from a later-stage slave controller 200, which is addressed to the master controller 100, to an earlier-stage slave controller 200 provided adjacent thereto (in the case of the slave controller 210, since there is no earlier-stage slave controller 200, the master controller 100).

It should be noted that, in each functional block, it is assumed that the slave controller 200, which is a transmission source of data, is assigned. For example, the slave controller 210 is assigned as the slave controller 200 that transmits data to one control target in the image forming section 320, and the slave controller 220 is assigned as the slave controller 200 that transmits data to one control target in the image reading section 330. Moreover, for example, it may be possible to assign the slave controller 210 as the slave controller 200 that transmits data to one control target in the image forming section 320, and to assign the slave controller 220 as the slave controller 200 that transmits data to another control target in the image forming section 320.

### <Configuration of Master Controller>

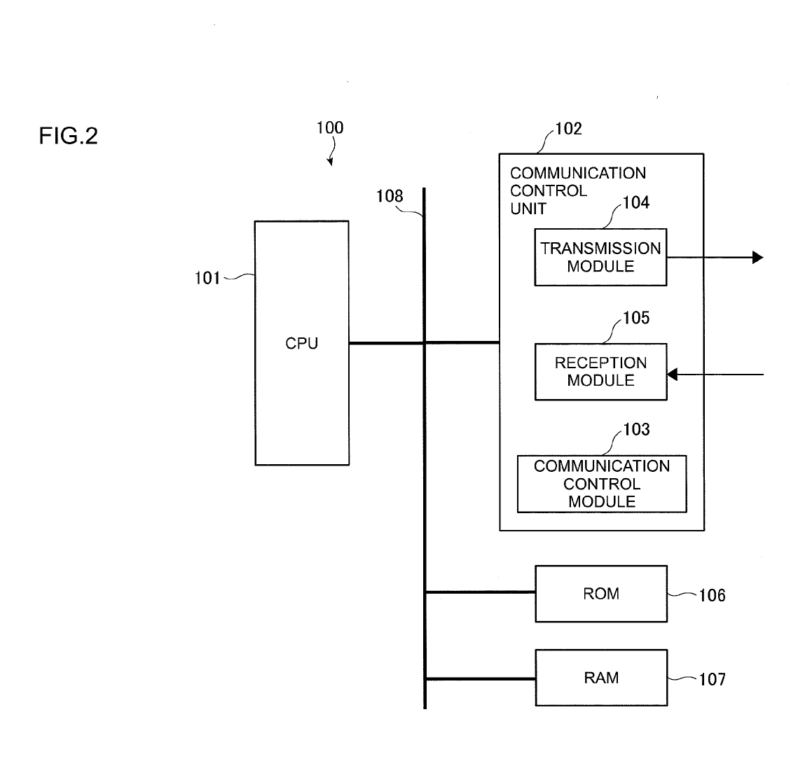

Next, a configuration of the master controller 100 will be described. FIG. 2 is a diagram showing a configuration example of the master controller 100. The master controller 100 includes a CPU 101, a communication control unit 102, a ROM 106 and a RAM 107. The master controller 100 further includes a data bus 108 that transmits and receives data among the CPU 101, the communication control unit 102, the ROM 106 and the RAM 107. The data bus 108 is a parallel bus that includes plural signal lines.

Then, when the power of the image forming apparatus 10 is turned on, the CPU 101 reads a program and data stored in the ROM 106 into the RAM 107 via the data bus 108 and decompresses thereof, to thereby execute the program. By execution of the program, control of the image forming apparatus 10 is carried out.

Moreover, the communication control unit 102 includes a communication control module 103, a transmission module 104 and a reception module 105.

The communication control module 103 controls data transmission/reception by the transmission module 104 and the reception module 105 in accordance with the control of the CPU 101. Here, upon receiving information to be transmitted to the slave controller 200 from the CPU 101 via the data bus 108 (a parallel signal), the communication control module 103 packetizes the parallel signal that has been received. Then, the communication control module 103 outputs the packet to the transmission module 104. Moreover, in packetizing the parallel signal, the communication control module 103 carries out a process related to CRC, to thereby add a CRC code to the packet.

The CRC is a kind of function that outputs a fixed-size value with respect to data input of arbitrary length, and is also a kind of error detection symbol for detecting successive errors. For example, target communication data is divided by a constant, and then a residue thereof is used as a CRC code for error checking. Then, in the error checking, the CRC code added to the packet and a CRC code newly calculated based on the packet are compared, and it is determined that there is no error when these CRC codes coincide with each other. On the other hand, if these CRC codes do not coincide with each other, it is determined that there occurs an error by, for example, application of the noise to the packet. In the exemplary embodiment, the CRC code is calculated by using the portions from a header portion to a data portion of a packet, namely, all portions of the packet except for the CRC code. Details of such a data structure of the packet will be described later. Moreover, in the exemplary embodiment, the CRC code is used as an example of error determination information.

Moreover, the communication control module 103 carries out error checking with respect to the packet in a parallel form received from the reception module 105 based on the CRC code. If there is no error, the communication control module 103 decodes the packet to take out the data included in the packet, and outputs the data that has been taken out to the CPU 101 via the data bus 108. On the other hand, if there is any error, the communication control module 103 discards the packet.

The transmission module 104 converts the packet inputted by the communication control module 103 from the parallel signal into the serial signal, and transmits the converted packet to the first slave controller 210 via the serial communication line.

Upon receiving the packet from the first slave controller 210 via the serial communication line, the reception module 105 converts the received packet from the serial signal into the parallel signal, and outputs the converted packet to the communication control module 103.

### <Configuration of Slave Controller>

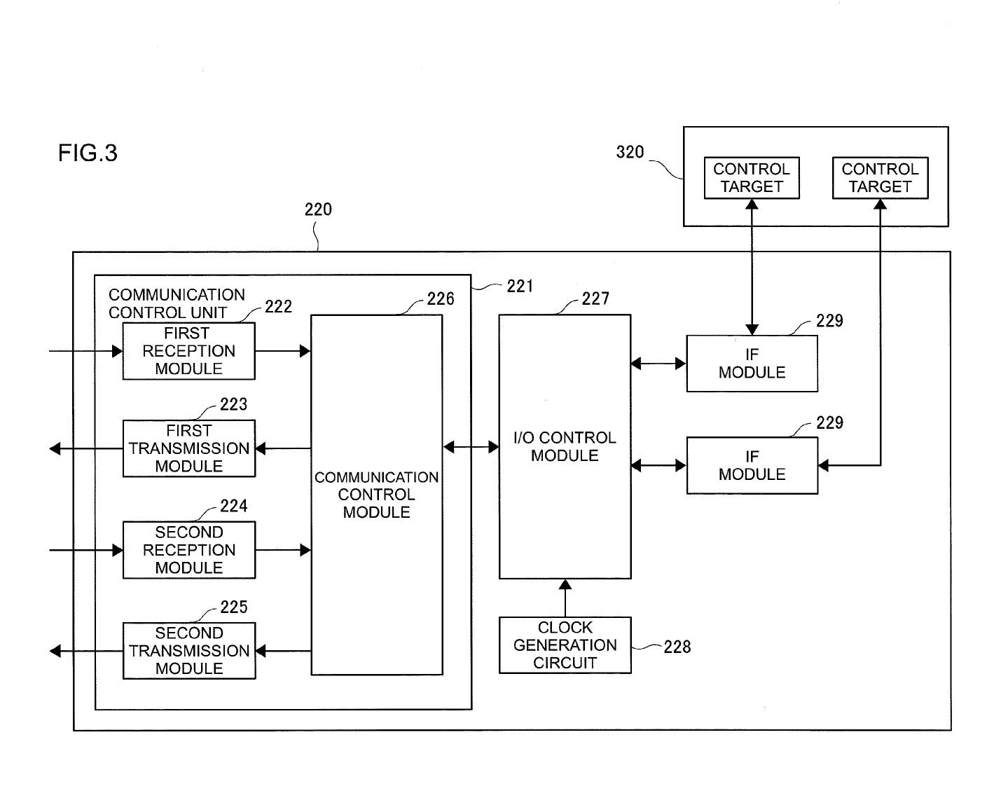

Next, a configuration of the slave controller 200 will be described. FIG. 3 is a diagram showing a configuration example of the slave controller 220. The slave controller 220 includes a communication control unit 221, an I/O (Input/Output) control module 227, a clock generation circuit 228 and IF modules 229. It should be noted that, here, the configuration of the slave controller 220 will be described; however, other slave controllers 200 (the slave controller 210, the slave controller 230 and the slave controller 240) are also configured in the same manner.

First, the I/O control module 227 is connected to the IF modules 229, and is also connected to the communication control unit 221 and the clock generation circuit 228. Then, the I/O control module 227 outputs the data received from the communication control unit 221 to one of the IF modules 229 that is designated. Moreover, the I/O control module 227 outputs the data received from the I/F modules 229 to the communication control unit 221.

The IF modules 229 are connected to the control targets in the functional block, and when the data is received from the I/O control module 227, output the received data to the control targets. Based on the outputted data, processing is carried out in the control target. Moreover, when the IF modules 229 receive data from the control targets in the functional block, the IF modules 229 output the received data to the I/O control module 227. The data from the control target is addressed to the master controller 100, and therefore, the data is transmitted to the master controller 100 via the communication control unit 221.

It should be noted that, in the configuration example shown in FIG. 3, the configuration is assumed to have two IF modules 229; however, there may be only one IF module 229 or three or more IF modules 229. Moreover, with regard to the control target, the configuration is assumed such that the control targets in the image forming section 320 are connected as the control targets; however, the control targets in other functional blocks may be connected.

The clock generation circuit 228 generates a clock signal, and transmits the clock signal to the I/O control module 227. To additionally describe, transmission and reception of data between the I/O control module 227 and the IF modules 229 are carried out in synchronization with the clock signal generated by the clock generation circuit 228.

The communication control unit 221 includes a first reception module 222, a first transmission module 223, a second reception module 224, a second transmission module 225 and the communication control module 226. Then, the first reception module 222 and the first transmission module 223 are used for communication with the earlier-stage slave controller 210, whereas the second reception module 224 and the second transmission module 225 are used for communication with the next-stage slave controller 230.

First, upon receiving the packet from the earlier-stage slave controller 210, the first reception module 222 converts the received packet from the serial signal into the parallel signal. Here, the first reception module 222 does not convert all of the packet into the parallel signal, but stores only the header portion, which is a part of the packet, in a buffer and converts thereof into the parallel signal. Then, the first reception module 222 decodes the header portion converted into the parallel signal, to thereby determine whether or not the ID assigned to the packet is the same as the ID assigned to its own slave controller 220 (hereinafter, the ID assigned to itself is referred to as an own-controller's ID).

In the case where both IDs are the same, the first reception module 222 identifies the received packet as a packet addressed to the slave controller 220 of its own. Then, the first reception module 222 converts the remaining portions other than the header portion from the serial signal into the parallel signal. Then, the first reception module 222 outputs the packet having been subjected to the parallel conversion to the communication control module 226.

On the other hand, in the case where both IDs are different from each other, the first reception module 222 subsequently carries out a process that corresponds to the ID assigned to the packet.

In the case where both IDs are different from each other and the ID assigned to the packet is larger than the own-controller's ID, the first reception module 222 outputs the packet to the communication control module 226 as a packet to be transmitted to the next-stage slave controller 230. However, in a case where the ID assigned to the packet is larger than the ID of the last slave controller 240 existing in the latest stage in the cascade connection, it is considered that, since noise is applied to the header portion, the value of the ID falls out of the range of normal assignment of the ID value. In this case, the packet is not transferred to the next-stage slave controller 230, and the first reception module 222 outputs the packet to the communication control module 226 as a packet to be discarded.

Moreover, in a case where both IDs are different from each other, and the ID assigned to the packet is smaller than the own-controller's ID, it is considered that the ID should be received by an earlier-stage slave controller (in the example shown in FIG. 3, the slave controller 210) under normal circumstances, and the ID is changed by application of noise to the header portion during a period, for example, from transmission of the packet by the slave controller 210 to reception of the packet by the slave controller 220. In this case, the packet is not transferred to the next-stage slave controller 230, and the first reception module 222 outputs the packet to the communication control module 226 as a packet to be discarded.

Next, the first transmission module 223 transfers the packet inputted from the communication control module 226 to the earlier-stage slave controller 210. Here, the packet inputted from the communication control module 226 is an ACK (ACKnowledgement) packet that is a signal notifying that data transfer has been normally completed, a NACK (Negative ACKnowledgement) packet that is a signal notifying that data transfer has not been normally completed, a packet generated by the control target, or the like. Some of these packets are generated by the slave controller 220 or by the control target connected to the slave controller 220, and some other packets are transferred from a later-stage slave controller 200 (in the example shown in FIG. 3, the slave controller 230 or the slave controller 240).

Upon receiving the packet from the later-stage slave controller 230 via the serial communication line, the second reception module 224 outputs the received packet to the communication control module 226. The packet outputted here is transmitted to the first transmission module 223 via the communication control module 226.

The second transmission module 225 converts the packet inputted by the communication control module 226 from the parallel signal into the serial signal, and transmits the converted packet to the next-stage slave controller 230 via the serial communication line. Here, in the packet inputted from the communication control module 226, only the header potion has been subjected to parallel conversion by the first reception module 222; therefore, the second transmission module 225 converts the header portion into the serial signal again, to thereby transfer the packet to the next-stage slave controller 230.

Next, in a case where the communication control module 226 receives a packet addressed to its own slave controller 220 from the first reception module 222, the communication control module 226 carries out the error checking based on the CRC code. If there is no error, the communication control module 226 carries out a process for accepting the packet as the one addressed to its own slave controller 220. Here, the communication control module 226 decodes the packet to take out the data included in the packet, and outputs the data that has been taken out to the I/O control module 227. Then, the communication control module 226 transmits the ACK packet, whose destination address is set to the master controller 100, to the earlier-stage slave controller 210 via the first transmission module 223.

On the other hand, if there is any error in the packet, the communication control module 226 discards the packet. Then, the communication control module 226 transmits the NACK packet, whose destination address is set to the master controller 100, to the earlier-stage slave controller 210 via the first transmission module 223.

Moreover, in the case where the communication control module 226 receives a packet to be transferred to the next-stage slave controller 230 from the first reception module 222, the communication control module 226 transfers the packet to the next-stage slave controller 230 via the second transmission module 225.

Further, in the case where the communication control module 226 receives a packet to be discarded from the first reception module 222, the communication control module 226 discards the packet. Then, the communication control module 226 transmits the NACK packet, whose destination address is set to the master controller 100, to the earlier-stage slave controller 210 via the first transmission module 223.

Then, in the case where the communication control module 226 receives data or the like, which is generated by the control target, from the I/O control module 227, the communication control module 226 packetizes the received data and transmits thereof, while setting the destination address to the master controller 100, to the earlier-stage slave controller 210 via the first transmission module 223.

Moreover, in the case where the communication control module 226 receives a packet (the ACK packet, the NACK packet, those generated by the control target, or the like) addressed to the master controller 100 from the later-stage slave controller 230, the communication control module 226 transmits the received packet to the earlier-stage slave controller 210 via the first transmission module 223.

### <Data Structure of Packet>

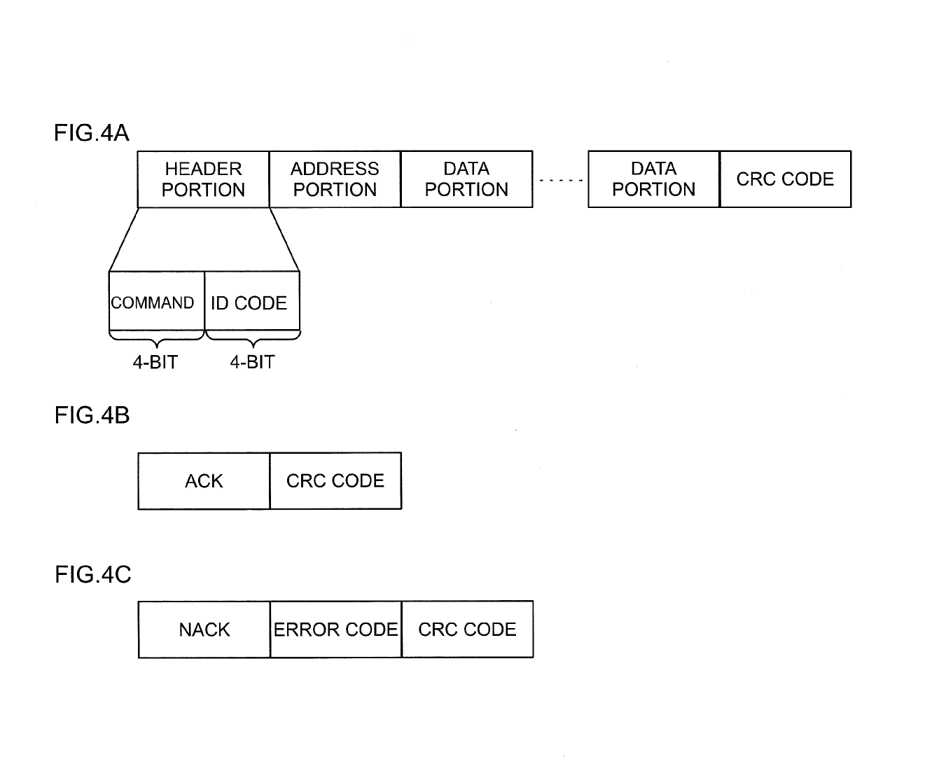

Next, description will be given of a data structure of the packet transmitted and received between the master controller 100 and each of the slave controllers 200. FIGS. 4A to 4C are diagrams each showing an example of a data structure of a packet.

First, FIG. 4A is a diagram showing an example of a data structure of a packet that is generated by the master controller 100 and then transmitted to the slave controller 200. In the packet shown in FIG. 4A, the header portion, the address portion, the data portion and the CRC code are arranged in the order from the top.

The header portion is divided into the 4-bit command and the 4-bit ID code.

In the command, an instruction of data writing (WRITE) in the control target in the functional block, which becomes a destination address, an instruction of data reading (READ) in the control target in the functional block, which becomes a destination address, and the like are included.

To the ID code, a bit string representing the own-controller's ID of the slave controller 200, which is the destination address of a packet, is assigned. The ID code includes 4 bits, and each slave controller 200 is assigned with the IDs “01” to “15”. However, in the exemplary embodiment, the ID code is not limited to 4 bits, and the ID code may be increased from 4 bits so as to make it possible to assign more IDs.

The address portion is configured with 16 bits, and indicates an address of a control target in a functional block as the destination address. For example, in a case where a packet is transmitted to the control target A under the control of the slave controller 210, the ID code is provided with an ID assigned to the slave controller 210 (ID=01), and the address portion is provided with an address of the control target A, to thereby generate the packet.

The data portion indicates data used for processing in the control target as the destination address, and N (one or more) pieces of data configured with, for example, 16 bits are added.

The CRC code is configured with 8 bits and is used for error checking that is carried out in each slave controller 200. The CRC code is, as described above, calculated by use of the header portion to the data portion of the packet (within an inch of the CRC code), and is set as a bit string.

FIG. 4B is a diagram showing an example of a data structure of the ACK packet that is transmitted to the master controller 100 as a destination address from the slave controller 200. In the ACK packet, an ACK command and the CRC code are arranged in the order from the top. The ACK command is provided with a bit string indicating that this packet is the ACK packet. Moreover, the CRC code is used for the error checking that is carried out in the master controller 100.

FIG. 4C is a diagram showing an example of a data structure of the NACK packet that is transmitted to the master controller 100 as a destination address from the slave controller 200. In the NACK packet, a NACK command, an error code and the CRC code are arranged in the order from the top. The NACK command is provided with a bit string indicating that this packet is the NACK packet. Moreover, the error code is provided with a bit string tailored to an error that causes transmission of the NACK packet. The CRC code is used for the error checking that is carried out in the master controller 100.

Here, as the error code, for example, in a case where an error occurs because an ID that is smaller than the own-controller's ID is assigned to the packet, a bit string corresponding to the error is provided. Moreover, for example, in a case where an error occurs because any control target to be the destination address designated in the address portion does not exist, a bit string corresponding to the error is provided as an error code. The error code is used in an analysis for making determination by the master controller 100 with respect to a cause of transmission of the NACK packet.

### <Processing Procedures of Packet in Slave Controller>

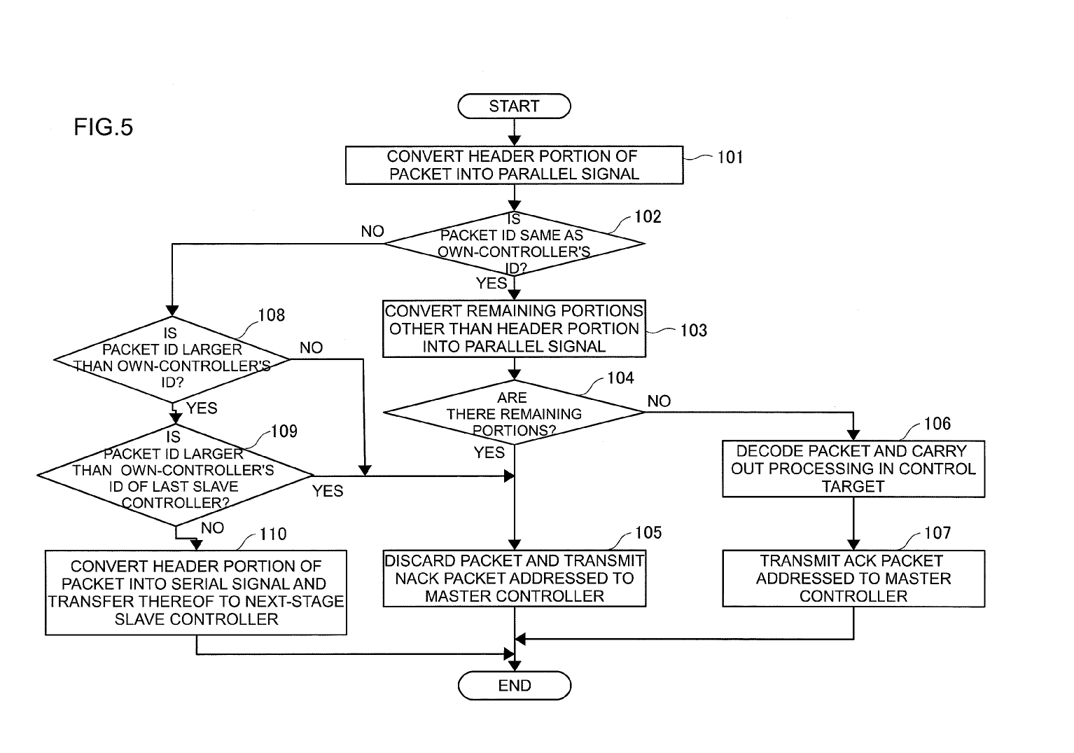

Next, description will be given of procedures in which the slave controller 200 processes the packet generated by the master controller 100. FIG. 5 is a flowchart showing an example of procedures in which the slave controller 220 processes the packet generated by the master controller 100. Here, the procedures carried out by the slave controller 220 will be described; however, in the other slave controllers 200 (the slave controller 210, the slave controller 230 and the slave controller 240), the same procedures are carried out.

First, upon receiving the packet from the earlier-stage slave controller 210 via the serial communication line, the first reception module 222 converts the received packet from the serial signal into the parallel signal (step 101). Here, the first reception module 222 stores only the header portion of the packet in a buffer, and converts thereof into the parallel signal. Then, the first reception module 222 determines whether or not an ID assigned to the packet is the same as the own-controller's ID (step 102).

In the case where both IDs are the same (Yes in step 102), the first reception module 222 identifies the received packet as a packet addressed to the slave controller 220 of its own, and also converts the remaining portions other than the header portion from the serial signal into the parallel signal (step 103). Then, the first reception module 222 outputs the packet that has been subjected to the parallel conversion to the communication control module 226. Upon receiving the packet from the first reception module 222, the communication control module 226 carries out the error checking based on the CRC code, to thereby determine whether or not there is any error (step 104).

In the case where there is an error (Yes in step 104), the communication control module 226 discards the packet, and outputs the NACK packet addressed to the master controller 100 to the first transmission module 223. Then, the first transmission module 223 transmits the NACK packet to the earlier-stage slave controller 210 (step 105), and thereby the process flow is completed.

On the other hand, in the case where it is determined in step 104 that there is no error (No in step 104), the communication control module 226 decodes the packet to take out the data included in the packet, and outputs the data that has been taken out to the I/O control module 227. The I/O control module 227 transmits the data received from the communication control module 226 to the control target via the IF module 229. Then, processing in the control target is carried out (step 106). Moreover, the communication control module 226 outputs the ACK packet addressed to the master controller 100 to the first transmission module 223. The first transmission module 223 transmits the ACK packet to the earlier-stage slave controller 210 (step 107), and thereby the process flow is completed.

Moreover, in step 102, in the case where the ID assigned to the packet and the own-controller's ID are different from each other (No in step 102), the first reception module 222 determines whether or not the ID assigned to the packet is larger than the own-controller's ID (step 108).

In the case where the ID assigned to the packet is larger than the own-controller's ID (Yes in step 108), the first reception module 222 further determines whether or not the ID assigned to the packet is larger than the own-controller's ID of the last slave controller 240 existing in the latest stage in the cascade connection (step 109).

In the case where the ID assigned to the packet is larger than the own-controller's ID of the last slave controller 240 (Yes in step 109), the first reception module 222 outputs the packet to the communication control module 226 as a packet to be discarded, and the process proceeds to step 105.

On the other hand, in the case where the ID assigned to the packet is the same as the own-controller's ID of the last slave controller, or is smaller than the own-controller's ID of the last slave controller (No in step 109), the first reception module 222 outputs the packet to the communication control module 226 as a packet to be transmitted to the next-stage slave controller 230. Upon receiving the packet, the communication control module 226 outputs the received packet to the second transmission module 225. Then, the second transmission module 225 converts the header portion of the packet from the parallel signal into the serial signal, to thereby transmit the packet to the next-stage slave controller 230 via the serial communication line (step 110). Then, the process flow is completed.

Further, in step 108, in the case where the ID assigned to the packet is smaller than the own-controller's ID (No in step 108), the first reception module 222 outputs the packet to the communication control module 226 as a packet to be discarded, and the process proceeds to step 105.

In this manner, upon receiving a packet, as a packet generated by the master controller 100, from the earlier-stage slave controller 210, the slave controller 220 first stores only the header portion in the buffer and carries out parallel conversion, and then determines whether or not the packet is addressed to its own slave controller 220. In the case where the packet is addressed to its own slave controller 220, the slave controller 220 carries out the parallel conversion on the remaining portions of the packet other than the header portion. Then, after carrying out the error checking, if there is no error, the slave controller 220 transmits the packet to the control target.

### <Specific Example of Noise Application to Packet>

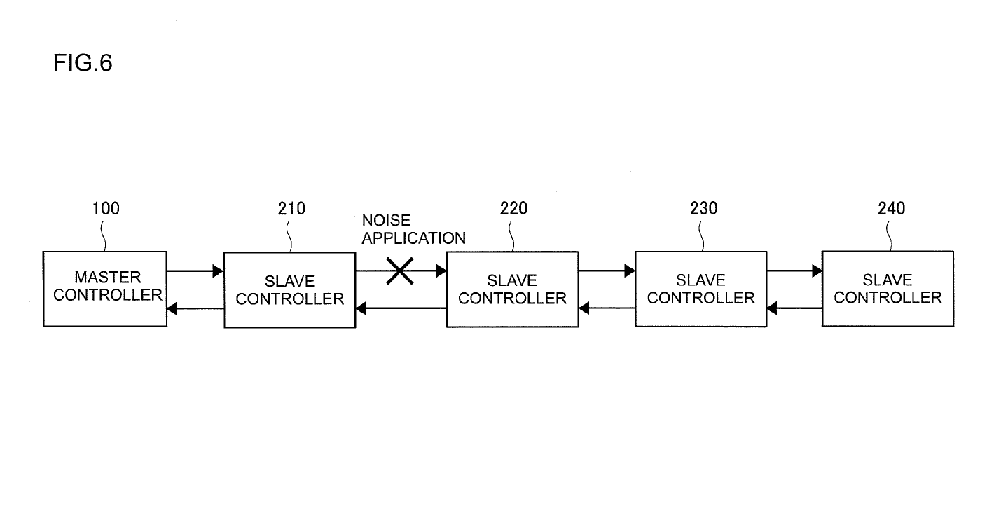

Next, description will be given of a process in a case where noise is actually applied to a packet by showing a specific example. FIG. 6 is a diagram illustrating an example of a process in the case where noise is applied to the packet. In the example shown in FIG. 6, it is assumed that, in the packet generated by the master controller 100, noise is applied between the slave controller 210 (ID=01) and the slave controller 220 (ID=02). Moreover, hereinafter, with respect to each of the example in which the noise is applied to the ID code in the header portion and the example in which the noise is applied to a portion other than the ID code, description will be given of the process carried out by the slave controller 220 (ID=02). Further, it is assumed that steps described as follows correspond to the respective steps in FIG. 5.

### [Specific Example in Which Noise is Applied to ID Code]

In the case where the noise is applied to the ID code, the ID indicated by the ID code is changed from its originally-assigned value to a different value. Here, as the patterns of changes, three patterns can be considered, namely, a case in which the ID assigned to the packet is smaller than the ID of the slave controller 220 that receives the packet (ID=02), a case in which the ID assigned to the packet is larger than the ID of the slave controller 220 (ID=02), and a case in which the ID assigned to the packet is the same as the ID of the slave controller 220 (ID=02).

First, there exists a case in which, though the original destination address of the packet is any one of the slave controller 220, the slave controller 230 and the slave controller 240 (ID=02, 03 or 04), due to the application of the noise, the ID of the packet becomes smaller than the ID of the slave controller 220 (ID=02). In this case, since it is determined, based on the ID, that the packet should be received by the earlier-stage slave controller 210, the slave controller 220 discards the packet and transmits the NACK packet to the master controller 100. In the flowchart shown in FIG. 5, negative determination (No) is made in step 102, and further, negative determination (No) is made in step 108. Then, the process proceeds to step 105.

Next, there exists a case in which, though the original destination address of the packet is any one of the slave controller 220, the slave controller 230 and the slave controller 240 (ID=02, 03 or 04), due to the application of the noise, the ID of the packet becomes larger than the ID of the last slave controller 240 (ID=04). In this case, since an ID that does not actually exist is assigned to the packet, the slave controller 220 discards the packet and transmits the NACK packet to the master controller 100. In the flowchart shown in FIG. 5, negative determination (No) is made in step 102, and positive determination (Yes) is made in step 108. Then, in the next step 109, positive determination (Yes) is made, and the process proceeds to step 105.

Moreover, there exists a case in which, though the original destination address of the packet is the slave controller 220 (ID=02), due to the application of the noise, the ID of the packet becomes “03” or “04”, which is larger than the ID of the slave controller 220 (ID=02). In this case, the slave controller 220 transfers the packet to the next-stage slave controller 230 (ID=03). In the flowchart shown in FIG. 5, negative determination (No) is made in step 102, and positive determination (Yes) is made in step 108. Then, in the next step 109, negative determination (No) is made, and the process proceeds to step 110.

Here, in the case where the ID of the packet becomes “03” by the noise, the slave controller 230 (ID=03) receives the packet as the one that is addressed to its own slave controller 230. However, since an error is detected by error checking in step 104, the slave controller 230 discards the packet and transmits the NACK packet (step 105). Similarly, in the case where the ID of the packet becomes “04” by the noise, the slave controller 240 (ID=04) receives the packet as the one that is addressed to its own slave controller 240. However, since an error is detected by error checking in step 104, the slave controller 240 discards the packet and transmits the NACK packet (step 105).

Moreover, the same is true for a case in which, though the original destination address of the packet is the slave controller 230 (ID=03), due to the application of the noise, the ID of the packet becomes the ID of the later-stage slave controller 240 (ID=04), and the packet is transmitted to the slave controller 240 (ID=04). Then, the slave controller 240 (ID=04) receives the packet as the one that is addressed to its own slave controller 240. However, since an error is detected by error checking in step 104, the slave controller 240 discards the packet and transmits the NACK packet (step 105). In a case where, though the original destination address of the packet is the slave controller 240 (ID=04), due to the application of the noise, the ID of the packet becomes the ID of the earlier-stage slave controller 230 (ID=03), similarly, the slave controller 230 discards the packet and transmits the NACK packet.

Further, there exists a case in which, though the original destination address of the packet is the slave controller 230 or the slave controller 240 (ID =03 or 04), due to the application of the noise, the ID of the packet becomes the same as the ID of the slave controller 220 (ID=02). In this case, the slave controller 220 receives the packet as the one that is addressed to its own slave controller 220. However, since an error is detected by error checking, the slave controller 220 discards the packet and transmits the NACK packet to the master controller 100. In the flowchart shown in FIG. 5, positive determination (Yes) is made in step 102, and further, positive determination (Yes) is made in step 104. Then, the process proceeds to step 105.

[Specific Example in Which Noise is Applied to Portion Other than ID Code]

As the patterns in the case where the noise is applied to a portion other than the ID code, two patterns can be considered, namely, a case in which the destination address of the packet is the slave controller 220 (ID=02) and a case in which the destination address of the packet is the slave controller 200 in a stage later than the slave controller 220 (in the example shown in FIG. 6, the slave controller 230 or the slave controller 240).

First, in the case where the destination address of the packet is the slave controller 220 (ID=02), the slave controller 220 receives the packet as the one that is addressed to its own slave controller 220. However, since an error is detected by the error checking, the slave controller 220 discards the packet and transmits the NACK packet to the master controller 100. In the flowchart shown in FIG. 5, positive determination (Yes) is made in step 102, and further, positive determination (Yes) is made in step 104. Then, the process proceeds to step 105.

Next, in the case where the destination address of the packet is the slave controller 200 in a stage later than the slave controller 220 (ID=03 or 04), the slave controller 220 transfers the packet to the next-stage slave controller 230 (ID=03). In the flowchart shown in FIG. 5, negative determination (No) is made in step 102, positive determination (Yes) is made in step 108, and negative determination (No) is made in step 109. Then, the process proceeds to step 110.

Here, in the case where the ID of the packet is “03”, the slave controller 230 (ID=03) receives the packet as the one that is addressed to its own slave controller 230. However, since an error is detected by the error checking in step 104, the slave controller 230 discards the packet and transmits the NACK packet (step 105). Similarly, in the case where the ID of the packet is “04”, the slave controller 240 (ID=04) receives the packet as the one that is addressed to its own slave controller 240. However, since an error is detected by the error checking in step 104, the slave controller 230 discards the packet and transmits the NACK packet (step 105).

As described above, upon receiving a packet generated by the master controller 100, the slave controller 200 first stores only the header portion in the buffer and carries out parallel conversion, and then determines whether or not the packet is addressed to its own slave controller 200 based on the ID. In the case where the packet is addressed to its own slave controller 200, the slave controller 200 carries out the parallel conversion with respect to the remaining portions other than the header portion. Then, the slave controller 200 carries out the error checking and processes the packet. On the other hand, if the packet is addressed to a slave controller 200 that exists in a later stage than itself, the slave controller 200 transfers the packet to the next-stage slave controller 200.

To additionally describe, since the slave controller 200 stores only the 8-bit header portion and carries out the parallel conversion, in the case where, for example, an 8-bit CPU is used, the conversion corresponds to a process of one clock, and accordingly, the process is carried out by a single calculation. Moreover, since the error checking is performed on the received packet, communication quality is maintained. Consequently, as compared to a configuration in which, for example, the slave controller 200 buffers all portions of the packet and transfers the packet to the next-stage slave controller 200, in the image forming apparatus 10 of the exemplary embodiment, the communication quality is ensured and the time for transferring the packet to the next-stage slave controller 200 is reduced.

Moreover, the slave controller 200 that has received the packet makes determination whether the packet is addressed to itself, and in the case where the packet is addressed to a later-stage slave controller 200, transfers the packet to the next-stage slave controller 200. Consequently, as compared to a configuration in which, for example, the packet is transferred to all of the slave controllers 200 and each of the slave controllers 200 makes determination whether or not the packet is addressed to itself, in the image forming apparatus 10 according to the exemplary embodiment, the traffic amount of the packet transmitted and received within the image forming apparatus 10 is reduced.

Further, the slave controller 200 that has received the packet discards the packet in the case where the ID assigned to the packet is smaller than the own-controller's ID of itself, or in the case where the ID assigned to the packet is larger than the own-controller's ID of the last slave controller 240. For example, if the packet is not discarded in the case where the ID assigned to the packet is smaller than the own-controller's ID of itself or in the case where the ID assigned to the packet is larger than the own-controller's ID of the last slave controller 240, the process for the packet is not carried out, and accordingly, any of the slave controllers 200 does not make a response to the master controller 100. In this case, the master controller 100 results in waiting for a response (ACK or NACK) to the packet until an error of timeout or the like occurs, and as a whole, the process carried out by the master controller 100 is delayed. In other words, for example, as compared to a configuration in which the packet is not discarded even in the case where the ID assigned to the packet is smaller than the own-controller's ID of itself or in the case where the ID assigned to the packet is larger than the own-controller's ID of the last slave controller 240, in the image forming apparatus 10 according to the exemplary embodiment, a response with respect to the packet in which an error occurs is returned to the master controller 100, and accordingly, the process by the master controller 100 is accelerated.

Moreover, in the exemplary embodiment, it is assumed that the CRC code is used for checking the error in the packet; however, there is no limitation to such a configuration. For example, not the CRC code but the checksum may be used, and any system may be used as long as such a system is capable of detecting the error.

Moreover, so far the description has been given of the example in which the master controller 100 and the slave controllers 200 according to the exemplary embodiment are applied to the image forming apparatus 10; however, the present invention is not limited to such a configuration. The present invention is applicable to various kinds of apparatuses that control driving of various kinds of equipment other than the equipment for image formation.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiments was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication system comprising:
a master controller that generates a packet; and
a plurality of slave controllers that accept the packet generated by the master controller, wherein
the plurality of slave controllers are serially connected via a serial communication line, a first slave controller of the plurality of slave controllers is connected to the master controller via the serial communication line, and each of the plurality of slave controllers, upon obtaining the packet generated by the master controller, converts a part of the packet from a serial signal into a parallel signal, and if the packet is not addressed to the slave controller itself, discards the packet or transfers the packet to a later-stage slave controller connected via the serial communication line.

2. The communication system according to claim 1, wherein
each of the plurality of slave controllers has identifying information assigned to become larger in order from the first slave controller connected to the master controller toward a last slave controller, and
the identifying information indicating a slave controller as a destination address of the packet is included in the part of the packet.

3. The communication system according to claim 2, wherein, in a case where the identifying information assigned to the obtained packet is smaller than the identifying information assigned to itself, the slave controller discards the packet and returns a response to the master controller, and, in a case where the identifying information assigned to the obtained packet is larger than the identifying information assigned to itself, the slave controller transfers the packet to the later-stage slave controller.

4. The communication system according to claim 2, wherein, in a case where the identifying information assigned to the obtained packet is larger than the identifying information assigned to the last slave controller, the slave controller discards the packet, without transferring thereof to the later-stage slave controller, and returns a response to the master controller.

5. The communication system according to claim 3, wherein, in a case where the identifying information assigned to the obtained packet is larger than the identifying information assigned to the last slave controller, the slave controller discards the packet, without transferring thereof to the later-stage slave controller, and returns the response to the master controller.

6. The communication system according to claim 2, wherein
the master controller adds error determination information with respect to a generated packet to the packet,
in a case where the identifying information assigned to the obtained packet is same as the identifying information assigned to itself, the slave controller generates error determination information with respect to the packet, and
the slave controller carries out a process for accepting the packet as being addressed to itself if the generated error determination information is same as the error determination information added to the packet, and discards the packet and returns a response to the master controller if the generated error determination information is different from the error determination information added to the packet.

7. The communication system according to claim 3, wherein
the master controller adds error determination information with respect to a generated packet to the packet, and,
in a case where the identifying information assigned to the obtained packet is same as the identifying information assigned to itself, the slave controller generates error determination information with respect to the packet, and
the slave controller carries out a process for accepting the packet as being addressed to itself if the generated error determination information is same as the error determination information added to the packet, and discards the packet and returns a response to the master controller if the generated error determination information is different from the error determination information added to the packet.

8. The communication system according to claim 4, wherein
the master controller adds error determination information with respect to a generated packet to the packet, and,
in a case where the identifying information assigned to the obtained packet is same as the identifying information assigned to itself, the slave controller generates error determination information with respect to the packet, and
the slave controller carries out a process for accepting the packet as being addressed to itself if the generated error determination information is same as the error determination information added to the packet, and discards the packet and returns a response to the master controller if the generated error determination information is different from the error determination information added to the packet.

9. The communication system according to claim 5, wherein
the master controller adds error determination information with respect to a generated packet to the packet, and,
in a case where the identifying information assigned to the obtained packet is same as the identifying information assigned to itself, the slave controller generates error determination information with respect to the packet, and
the slave controller carries out a process for accepting the packet as being addressed to itself if the generated error determination information is same as the error determination information added to the packet, and discards the packet and returns a response to the master controller if the generated error determination information is different from the error determination information added to the packet.

10. An image forming apparatus comprising:
an image forming section that forms an image; and
a master controller and a plurality of slave controllers that accept a packet generated by the master controller for controlling image formation in the image forming section, wherein
the plurality of slave controllers are serially connected via a serial communication line, a first slave controller of the plurality of slave controllers is connected to the master controller via the serial communication line, and each of the plurality of slave controllers, upon obtaining the packet generated by the master controller, converts a part of the packet from a serial signal into a parallel signal, and if the packet is not addressed to the slave controller itself, discards the packet or transfers the packet to a later-stage slave controller connected via the serial communication line.

11. A communication method used in a communication system including a master controller that generates a packet and a plurality of slave controllers that accept the packet generated by the master controller, the method comprising:
serially connecting the plurality of slave controllers via a serial communication line;
connecting a first slave controller of the plurality of slave controllers to the master controller via the serial communication line; and,
in each of the plurality of slave controllers, upon obtaining the packet generated by the master controller, converting a part of the packet from a serial signal into a parallel signal and if the packet is not addressed to the slave controller itself, discarding the packet or transferring the packet to a later-stage slave controller connected via the serial communication line.
